(19) United States
(12) Patent Application Publication
(10) Pub. No.: US 2007/0182854 A1
(43) Pub. Date: Aug. 9, 2007

(54) Drive circuit and method for screen horizontal scroll and an electronic device using the same

(76) Inventors: Tian-Hau Chen, Hsinhua (TW); Chih-Heng Chu, Hsinhua (TW); Zc-Chen Chen, Hsinhua (TW)

Correspondence Address: J.C. Patents, Inc., Suite 250, 4 Venture, Irvine, CA, 92618, US

(21) Appl. No.: 11/407,443

(22) Filed: Apr. 19, 2006

(30) Foreign Application Priority Data
Feb. 9, 2006 (TW) 95104330

(51) Int. Cl. H04N 5/44

(52) U.S. Cl. 348/561

(57) ABSTRACT

A drive circuit and method for screen horizontal scroll and an electronic device using the same are provided. Channel data is shifted between channels, such that the distance and the rate required for the screen horizontal scroll are achieved. The scrolled (shifted) channel data will be written back into a memory inside the electronic device to update the memory. The memory sends out the updated channel data, without re-calculating the channel data by a microprocessor. With channel data shifted and written back into the memory, the screen image shown in the electronic device is horizontally scrolled.

### BACKGROUND OF THE INVENTION

1. Field of Invention

The present invention relates to a drive circuit and method for screen horizontal scroll and an electronic device using the same, and more particularly to a drive circuit and method for horizontally scrolling a screen by shifting data between channels and then writing the data back into a memory, and an electronic device using the same.

2. Description of Related Art

Electronic devices, e.g., cellular phones, play a crucial role in modern life. Under some circumstances, such as standby mode or power-saving mode, the screen may need to be horizontal scrolled.

In the drive circuits of existing cellular phones, the screen horizontal scroll is usually achieved using a microprocessor. The microprocessor continuously sends out data to a memory inside the cellular phone, to update the channel data therein. Next, the memory sends the updated channel data to the drive circuit, such that the drive circuit continuously changes the channel data to achieve the screen horizontal scroll.

However, since the microprocessor is used to continuously send out data to achieve the screen horizontal scroll, the microprocessor is always in operation, thus increasing the power consumption of the cellular phone, which is undesirable. A controlling mechanism with a low circuit cost and a low controlling complexity is required.

In view of the above, the present invention provides a drive circuit and method which can be easily controlled by somewhat increasing the circuit area, and an electronic device using the same, wherein the screen horizontal scroll is achieved without using a microprocessor of the device to continuously send out data.

### SUMMARY OF THE INVENTION

An object of the present invention is to provide a drive circuit and method, and an electronic device using the same, wherein the function of screen scroll of the device is achieved without using a microprocessor of the device to continuously send out data.

Another object of the present invention is to provide a drive circuit and method, and an electronic device using the same, wherein when the screen is scrolled, data stored in a memory inside the device can be selectively switched to different channels, so as to achieve the required distance and rate for the screen scrolling.

Yet another object of the present invention is to provide a drive circuit and method, and an electronic device using the same, wherein when the screen is scrolled, the scrolled (shifted) data is written back into a memory inside the device to reduce the controlling complexity.

To achieve the above and other objects, the present invention provides a drive circuit for screen horizontal scroll and an electronic device using the same. The electronic device comprises a microprocessor, a memory, a buffer memory, a drive circuit, and a display device. The buffer memory receives and sends out each buffer data of each channel sent out by the memory. The control unit inside the drive circuit sends out a write back signal, a horizontal scroll enable signal and a select signal. When the screen is to be horizontally scrolled, the write back signal and the horizontal scroll enable signal are actuated. When the screen is not required to be horizontally scrolled, a data switching block in the drive circuit bypasses each buffer data in each channel, and transfers them to a source driver for driving the display device. When the screen is to be horizontally scrolled, the data switching block shifts each buffer data in each channel according to the select signal, and transfers them to the source driver for driving the display device. A data write back unit in the drive circuit is used to write the shifted buffer data of each channel output by the data switching block back into the memory according to the write back signal.

The data switching block includes: a multiplexer for receiving buffer data corresponding to other channels, the multiplexer sending out one of the buffer data corresponding to other channels according to the select signal; a flip-flop, for outputting the output signal of the multiplexer into the shifted buffer data of each channel and an inverted signal thereof; a plurality of inverters, for enhancing the driving capability for the shifted buffer data of each channel; and a switch, wherein when the screen is to be horizontally scrolled, the switch transmits the shifted buffer data of each channel to the source driver in response to the horizontal scroll enable signal, while when the screen is not to be horizontally scrolled, the switch transmits each buffer data of each channel to the source driver. The data write back unit utilizes two switching units to write the shifted buffer data of each channel and the inverted signal back into the memory.

To achieve the above objects, the present invention also provides a method for screen horizontal scroll in an electronic device. When the screen is to be horizontally scrolled, the write back signal is actuated; each buffer data of each channel is shifted according to the select signal; and the switched data is displayed on a display device. The shifted buffer data of each channel is written back into a memory inside the electronic device. If the screen is not to be horizontally scrolled, each buffer data of each channel is directly bypassed for being displayed on the display device. One of the buffer data corresponding to other channels and an inverted signal thereof are selected and output according to the select signal and the actuated write back signal. Through this method, the driving capability for the shifted buffer data of each channel is also enhanced.

The present invention further provides a method for screen horizontal scroll adapted for use in a display device, which includes the following steps: receiving a frame signal; horizontally scrolling the frame signal according to a select signal, so as to generate a scrolled frame signal; storing the scrolled frame signal; and displaying the frame according to the scrolled frame signal.

Through the above structure, the screen horizontal scroll is achieved in the present invention with a low circuit cost and a low controlling complexity without continuous data resending by a microprocessor.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram of a cellular phone according to an embodiment of the present invention.

FIG. 2 is a circuit block diagram of a data switching block in FIG. 1.

FIG. 3 is a circuit block diagram of a data write back unit in FIG. 1.

FIG. 4 is a schematic view of the cellular phone 100 according to the embodiment of the present invention during the screen horizontal scroll.

### DESCRIPTION OF EMBODIMENTS

A drive circuit and method for screen horizontal scroll and a cellular phone or any other electronic device using the same are provided in an embodiment of the present invention. In this embodiment, channel data can be shifted between channels to obtain the required distance and rate for the screen horizontal scroll. Since the image to be scrolled is continuous, this embodiment further considers the memory write back mechanism, such that channel data after each scroll (shift) may be written back into the memory. A memory in the cellular phone or any other electronic device can directly output updated channel data without recalculation of the shifted channel data by the microprocessor. Through the channel data shifting and memory write back mechanism, the horizontal scroll of the screen image can be achieved. The horizontal scroll is performed, for example, when the cellular phone enters into a power-saving mode or standby mode, and then a certain picture which is horizontally moving may occur on the screen. In this embodiment, display data corresponding to this picture may be shifted, so as to achieve the screen horizontal scroll.

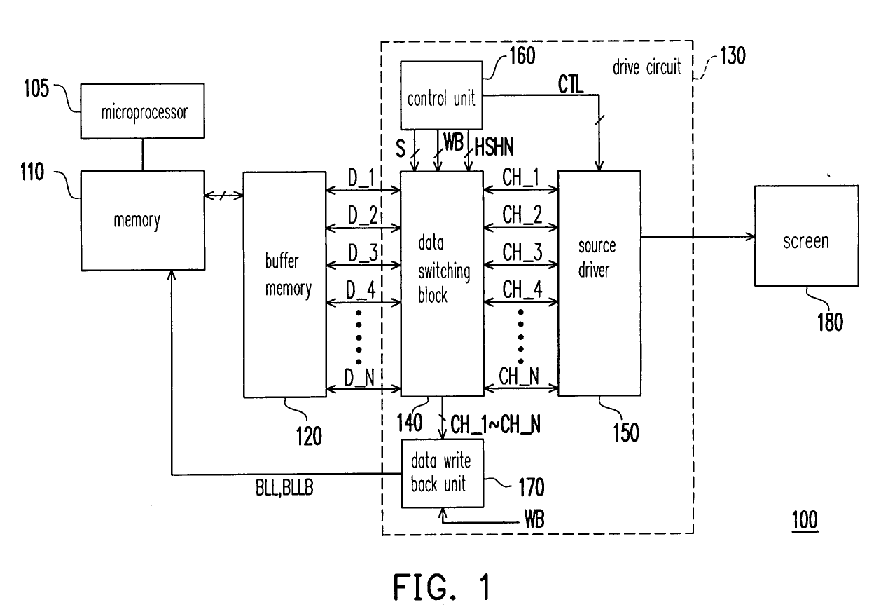

FIG. 1 is a block diagram of an embodiment of the present invention. It should be noted that, the following description is directed to how the screen horizontal scroll is performed, and thus other irrelevant parts will be omitted. As shown in FIG. 1, a cellular phone 100 comprises: a microprocessor 105, a memory 110, a buffer memory 120, a drive circuit 130, and a screen 180. The drive circuit 130 comprises a data switching block 140, a source driver 150, a control unit 160, and a write back unit 170.

The memory 110 is, for example, a static random access memory (SRAM). The memory 110 may receive data written by the microprocessor 105 inside the cellular phone 100, such that the data is sent to the drive circuit 130 for display on the screen 180 of the cellular phone. Herein, the structures of the microprocessor 105 and the screen 180 are not restricted, as long as the microprocessor 105 is able to send the data to the memory 110 and the screen 180 is able to display the data send out by the drive circuit 130.

The memory 110 stores data to be displayed beforehand. When a certain line is being displayed on the screen 180, the memory 110 may send the raw data of this line to the buffer memory 120. Herein, each line is assumed to include N channels, where N is a positive integer. The memory 110 receives the written-back data. As long as a corresponding word-line inside the memory is turned on, shifted data written back by the data write back unit 170 may be received through bit lines BLL and BLLB into the memory 110.

The buffer memory 120 is used to temporarily store the raw channel data sent out by the memory 110, and send out buffer data D_1˜D_N in parallel to the data switching block 140 inside the drive circuit 130. In this embodiment, the buffer data D_1˜D_N are all one bit each in length. For simplicity of illustration, the buffer data D_1 is considered to be the first data, whereas the buffer data D_N is considered to be the last data in this embodiment.

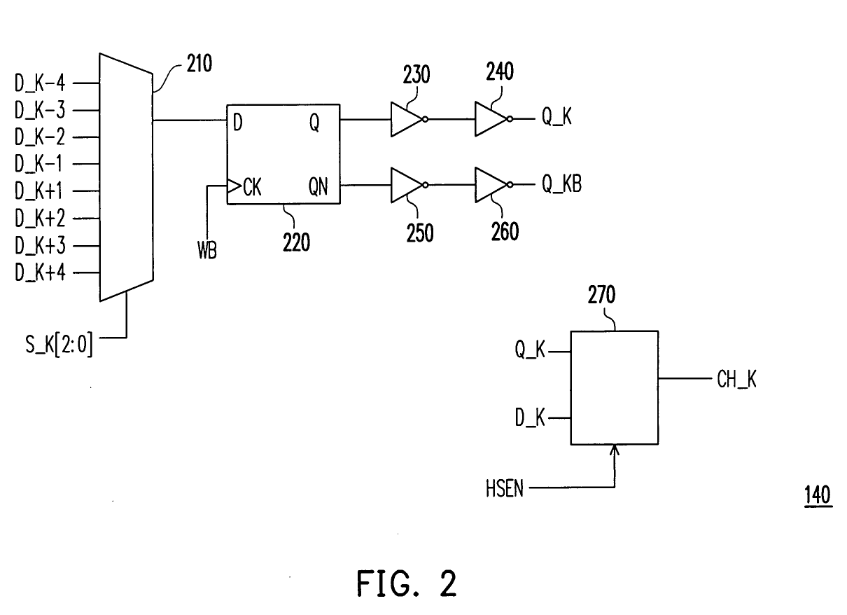

The data switching block 140 may determine whether the buffer data D_1˜D_N (also referred to as raw channel data) are to be shifted or directly bypassed according to a multiplexer control signal S, a write back signal WB, and a horizontal scroll enable signal HSEN sent out by the control unit 160; and then send out channel data CH_1˜CH_N. The circuit structure and operation of the data switching block 140 can be known with reference to FIG. 2.

The source driver 150 is used to receive the channel data CH_1˜CH_N (shifted buffer data or buffer data being the same as the raw channel data) sent out by the data switching block 140, and drives to display on the screen 180. Herein, the structure of the source driver 150 is not restricted, as long as it can be used to achieve the function required in this embodiment.

The control unit 160 may send out the multiplexer control signal S, the write back signal WB, and the horizontal scroll enable signal HSEN to the data switching block 140, so as to perform data shifting, if required. When the screen is to be horizontally scrolled, the write back signal WB and the horizontal scroll enable signal HSEN are actuated. Furthermore, the control unit 160 may also send out a control signal CTL to the source driver 150.

When the raw data has already been shifted by the data switching block 140, in order to reduce the controlling complexity, the data write back unit 170 may write the shifted data back into the memory 110, so as to update the corresponding data inside the memory 110. When the next frame is being displayed on the screen 180, if the screen horizontal scroll is still required, the memory 110 just sends out the updated data, and then the distance and the rate for the horizontal scroll are determined by the drive circuit 130. The distance in the horizontal scroll refers to how many channels the channel data is shifted.

As can be known from FIG. 1 and above description, in this embodiment, the microprocessor 105 firstly transfers initial channel data to the memory 110. Next, the memory 110 transfers the initial channel data to the buffer memory 120, and the drive circuit 130 drives to display on the screen 180 according to the buffer data of the buffer memory 120. After that, when the screen is to be horizontally scrolled, instead of recalculation of the channel data by the microprocessor 105, the control unit 160 determines the distance for shifting the channel data, and then transfers the shifted channel data to the source driver 150 for display on the screen 180. Meanwhile, the data write back unit 170 writes the shifted channel data back into the memory 110, so as to update the corresponding data inside the memory 110. The above steps are repeated, and thus the screen horizontal scroll is achieved without using the microprocessor 105 to continuously process and send out the channel data.

Now, how the data switching block 140 in FIG. 1 shifts data will be explained below with reference to FIG. 2. FIG. 2 is a circuit block diagram of the data switching block 140 in FIG. 1. It should be noted that, to simplify the diagram, only channel K (K is a natural number less or equal to N) has been depicted. The data switching block 140 at least comprises a multiplexer 210, a flip-flop 220, inverters 230˜260, and a switch 270. The multiplexer 210, the flip-flop 220, and the inverters 230˜260 are used to determine the distance for shifting the channel data; and the switch 270 is used to determine to select the shifted channel data or the channel data without being shifted to be output to the source driver 160.

The multiplexer 210, coupled to the buffer memory 120, is used to select one of the buffer data D_K−4, D_K−3, D_K−2, D_K−1, D_K+1, D_K+2, D_K+3, and D_K+4 (exclusive of D_K) in the adjacent channels according to a multiplexer control signal S_K[2:0] sent out by the control unit 160, so as to output the selected data to the flip-flop 220. The multiplexer control signal S in FIG. 1 includes the control signals S_1[2:0], S_2[2:0], . . . S_N[2:0]. In this embodiment, the control signal S_K[2:0] is 3-bit in length, so it can be used to select 2³=8 input signals D_K−4˜D_K−1 and D_K+1˜D_K+4. For example, when the control signal S_K[2:0] is 000, the multiplexer 210 selects the input signal D_K−4, that is, all the channel data is shifted backward by four channels, and when the control signal S_K[2:0] is 111, the multiplexer 210 selects the input signal D_K+4, that is, all the channel data is shifted forward by four channels, and so forth. The multiplexer 210 can be also configured as a 2M-to-1 multiplexer (M is a positive integer) as desired, and correspondingly, the control signal is also changed to a control signal S_K[M−1:0] with M bits.

The data input terminal D of the flip-flop 220 receives an output signal of the multiplexer 210, while the clock input terminal CK of the flip-flop 220 receives the write back signal WB output by the control unit 160. When the horizontal scroll is being performed, since the data write back mechanism is required to be enabled, the write back signal WB is actuated. Otherwise, when the horizontal scroll is not being performed, the write back signal WB will not be actuated.

The two output signals of the flip-slop 220 will be inverted respectively by the inverters 230/240 and 250/260. The inverters 203, 240, 250 and 260 are used as buffer circuits for enhancing the driving capability for the signals, and thus optional. The inverters 240 and 260 respectively output signals Q_K and Q_KB, wherein the output signal Q_K represents the shifted channel data of channel K, and the Q_KB is an inverted signal of Q_K.

The switch 270 receives the buffer data D_K output by the buffer memory 120 and the shifted data Q_K output by the inverter 240. The switch 270 determines to output either D_K or Q_K according to the horizontal scroll enable signal HSEN output by the control unit 160. The switch 270 outputs the signal CH_K to the source driver 150. When the horizontal scroll is to be performed, the control unit 160 may output the horizontal scroll enable signal HSEN in logic high, while when the horizontal scroll is not to be performed, the control unit 160 may output the horizontal scroll enable signal HSEN in logic low. When the horizontal scroll enable signal HSEN is logic high, the switch 270 may output the shifted data Q_K as the channel data CH_K to the source driver 150; otherwise, when the horizontal scroll enable signal HSEN is logic low, the switch 270 may output the buffer data D_K as the channel data CH_K to the source driver 150. That is, the switch 270 determines to output either the shifted data (Q_K) or the buffer data (D_K) without shifted to the source driver 150.

Through the architecture of FIG. 2, when the horizontal scroll is to be performed, the data switching block 140 determines the distance for horizontally shifting the channel data, and transfers the shifted data as the channel data CK_1˜CK_N to the source driver 150 for display on the screen 180. When the horizontal scroll is not to be performed, the data switching block 140 directly inputs the buffer data without being shifted D_1˜D_N to the source driver 150 for display on the screen 180.

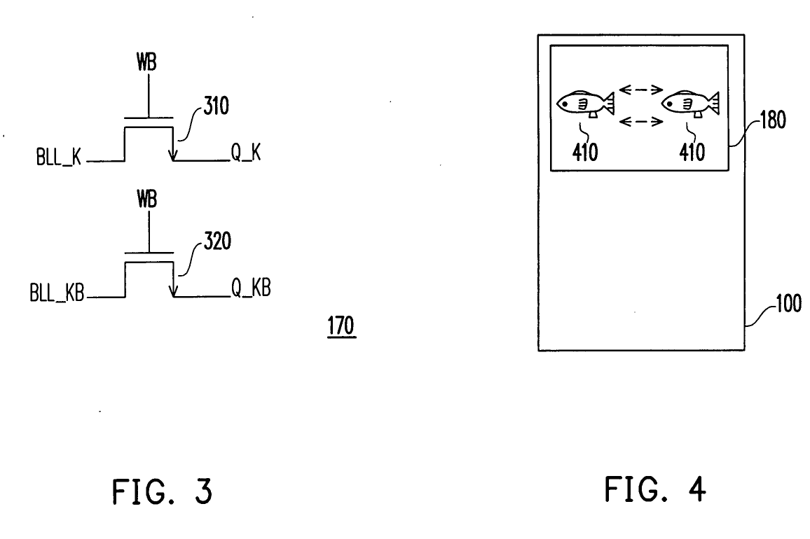

When the channel data is being horizontally moved, i.e., the channel data is being shifted between channels, the data write back mechanism is employed in the present invention to further reduce the controlling complexity. In this embodiment, the data write back unit 170 writes the shifted data back into the memory 110. FIG. 3 is a circuit block diagram of the data write back unit 170 in FIG. 1.

As shown in FIG. 3, the data write back unit 170 comprises switch transistors 310 and 320. As for the switch transistor 310, the source is coupled to the shifted signal Q_K; the gate is coupled to the write back signal WB; and the drain is coupled to a bit line BLL_K of the memory 110. As for the switch transistor 320, the source is coupled to the signal Q_KB; the gate is coupled to the write back signal WB; and the drain is coupled to a bit line BLL_KB of the memory 110. When the horizontal scroll is being performed, the write back signal WB is actuated, such that the switch transistors 310 and 320 are turned on. When the switch transistors 310 and 320 are ON, the signals Q_K and Q_KB will be written to the bit lines BLL_K and BLL_KB of the memory 110. Of course, when the data is to be written back, the word-line of the memory 110 has to be turned on. Thus, the operation of writing the shifted data back into the memory 110 is achieved.

In FIG. 1, the bit line BLL includes N bit lines BLL_1˜BLL_N, and the bit line BLLB includes N bit lines BLL_1B˜BLL_NB.

FIG. 4 is a schematic view of the cellular phone 100 according to an embodiment of the present invention during the screen horizontal scroll. As mentioned above, when the cellular phone 100 enters into the standby mode or the power saving mode, the picture 410 on the screen 180 may horizontally move leftward or rightward. When the screen is to be horizontally scrolled, the microprocessor 105 only transfers the initial channel data to the memory 110. Then, the screen horizontal scroll is achieved through the architecture in FIGS. 1˜3, without using the microprocessor 105 to generate the display data for each frame to the memory 110.

In the above embodiments, the horizontal movement is defined by the effect generated after the channel data has already been shifted.

To simplify the diagrams, FIGS. 1˜3 only depict that one channel only includes one channel data. Those skilled in the art know that how to change the circumstance in FIGS. 1˜3 into another in which one single channel relates to multiple channel data. For example, each channel corresponds to several elements 210˜270, and then the outputs of the switches 270 are combined into the channel data required by one channel.

In FIG. 2, the switch 270 can also be omitted, as long as the output signal Q_K is output to the source driver 150 as the output signal CH_K. The horizontal scroll enable signal HSEN can be incorporated into the multiplexer control signal S_K[2:0], i.e., becoming S_K[3:0], and the buffer data D_K is additionally coupled to the multiplexer 210 and selected through the multiplexer control signal S_K[3:0].

The implementation of the present invention is not limited by the above embodiment. For example, the data select mechanism in the above embodiment is achieved by employing D-type flip-flop together with the multiplexer for selecting the required data from among multiple data. The data switching mechanism can also be achieved by employing a multiple-to-one switch or multiple flip-flops or the combination thereof for selecting the desired data from among multiple data. Therefore, the D-type flip flop together with the multiplexer or the equivalent circuit thereof is referred to as “select unit”.

In addition, the function similar to that of the switch 270 inside the data switching block can also be achieved through a multiplexer, or a flip-flop, or a P-channel Metal-Oxide Semiconductor (PMOS) transistor, or an N-channel Metal-Oxide Semiconductor (NMOS) transistor, or a transmission gate, or a logic gate (e.g., AND gate and OR gate) or any combination thereof, as long as the device can achieve the function of outputting one of the data D_K and Q_K.

In addition, as for the data write back mechanism, other than the NMOS transistor, a flip-flop, a transmission gate, a PMOS transistor, or any combination thereof can also be used to write the data Q_K and Q_KB back into the memory.

The above embodiment is exemplarily illustrated with the whole screen being horizontally scrolled (i.e., the shifting distance for each channel data is the same). However, those skilled in the art know that the shifting distance for each channel data can be optionally determined according to the different control signals sent out by the control unit 160 to the data switching block 140, i.e., the shifting distance for each channel data can also be different. Therefore, the effect that a part of the picture on the screen 180 is horizontally scrolled, and a part of the picture is substantially or entirely not horizontally scrolled can be achieved.

The present invention is not limited to the cellular phone, and it can also be applied to any other handheld communication product, such as the PDA.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A drive circuit adapted for use in an electronic device, wherein the electronic device comprises a memory, a buffer memory and a display device, the buffer memory receives data from the memory as buffer data corresponding to a plurality of channels, and the drive circuit performs a screen horizontal scroll function to the display device, the drive circuit comprising:
a control unit, for sending out a write back signal and a select signal, the write back signal being actuated when the screen horizontal scroll function is active;
a data switching block, for receiving the buffer data, wherein when the screen horizontal scroll function is inactive, the data switching block bypasses the buffer data and when the screen is to be horizontally scrolled, the data switching block shifts the buffer data for outputting according to the select signal;
a source driver, for receiving the bypassed or shifted buffer data, so as to drive the display device; and
a data write back unit, for writing the shifted buffer data back into the memory according to the write back signal.

2. The drive circuit as claimed in claim 1, wherein the control unit further outputs a horizontal scroll enable signal which is actuated when the screen is to be horizontally scrolled.

3. The drive circuit as claimed in claim 2, wherein the data switching block comprises:
a select unit coupled to the buffer memory, for receiving the buffer data, wherein the select unit selects one of the buffer data according to the select signal and the write back signal, so as to output the shifted buffer data.

4. The drive circuit as claimed in claim 3, wherein the data switching block further comprises a plurality of inverters coupled to the select unit to enhance the driving capability for the shifted buffer data.

5. The drive circuit as claimed in claim 3, wherein the data switching block further comprises a switch for receiving the shifted buffer data and the buffer data, and the switch selectively transmits the shifted buffer data or the buffer data to the source driver according to the actuated horizontal scroll enable signal.

6. The drive circuit as claimed in claim 5, wherein the data write back unit comprises:
a first switching unit, for writing the shifted buffer data back into the memory according to the write back signal; and
a second switching unit, for writing an inverted signal of the shifted buffer data back into the memory according to the write back signal.

7. An electronic device with a screen horizontal scroll function, comprising:
a microprocessor for calculating and sending out channel data;
a memory coupled to the microprocessor, for receiving and outputting the channel data output by the microprocessor;
a buffer memory coupled to the memory, for receiving and outputting the channel data output by the memory as buffer data;
a drive circuit coupled to the buffer memory, for generating a write back signal and a select signal, wherein when the screen horizontal scroll function is active, the drive circuit shifts and then outputs the buffer data according to the select signal, and then writes the shifted buffer data back into the memory; and when the screen horizontal scroll function is inactive, the drive circuit bypasses the buffer data; and
a display device, coupled to the drive circuit and driven according to the shifted buffer data or the buffer data.

8. The electronic device as claimed in claim 7, wherein the drive circuit comprises:
a control unit, for sending out the write back signal, the select signal and a horizontal scroll signal, wherein when the screen horizontal scroll function is active, the horizontal scroll signal is actuated;
a data switching block coupled to the buffer memory and the control unit, for receiving the buffer data output by the buffer memory, wherein when the screen horizontal scroll function is inactive, the data switching block bypasses the buffer data;
and when the screen horizontal scroll function is active, the data switching block shifts and outputs the buffer data according to the select signal;
a source driver, for receiving the bypassed or shifted buffer data, so as to drive the display device; and
a data write back unit, for writing the shifted buffer data back into the memory according to the write back signal.

9. The electronic device as claimed in claim 8, wherein the data switching block comprises:
a select unit coupled to the buffer memory, for receiving the buffer data, wherein the select unit selects one of the buffer data according to the select signal and the write back signal, so as to output the shifted buffer data.

10. The electronic device as claimed in claim 9, wherein the data switching block further comprises a plurality of inverters to enhance the driving capability for the shifted buffer data.

11. The electronic device as claimed in claim 9, wherein the data switching block further comprises a switch for receiving the shifted buffer data and the buffer data, and the switch selectively transmits the shifted buffer data or the buffer data to the source driver according to the actuated horizontal scroll enable signal.

12. The electronic device as claimed in claim 9, wherein the data write back unit comprises:
a first switching unit, for writing the shifted buffer data back into the memory according to the write back signal; and
a second switching unit, for writing an inverted signal of the shifted buffer data back into the memory according to the write back signal.

13. A method for screen horizontal scroll adapted for use in an electronic device having a display device and a memory, comprising the steps of:
receiving buffer data from the memory;
shifting the buffer data and writing the shifted buffer data back into the memory when the screen horizontal scroll is active;
bypassing the buffer data when the screen horizontal scroll is inactive; and
driving the display device according to the shifted buffer data or the bypassed buffer data.

14. The method as claimed in claim 13, wherein when the screen horizontal scroll is active, the method further comprises steps of:
reading and shifting the shifted buffer data from the memory; and
driving the display device according to the last-shifted buffer data.

15. A method for screen horizontal scroll adapted for use in a display device, comprising steps of:
receiving a frame signal;
horizontally scrolling the frame signal according to a select signal, so as to generate a scrolled frame signal;
storing the scrolled frame signal; and
displaying the frame according to the scrolled frame signal.

16. The method as claimed in claim 15, further comprising steps of:
reading the scrolled frame signal that is stored; and
horizontally scrolling the scrolled frame signal according to the select signal.
